(19) United States
(12) Patent Application Publication
(10) Pub. No.: US 2020/0320305 A1
(43) Pub. Date: Oct. 8, 2020

(54) SPORTS GAME RECORDING AND BROADCASTING SYSTEM USING SMART DEVICE

(71) Applicant: SECOND GROUND INC., Daejeon (KR)

(72) Inventor: Dae Gyu PARK, Daejeon (KR)

(73) Assignee: SECOND GROUND INC., Daejeon (KR)

(21) Appl. No.: 16/956,359

(22) PCT Filed: Mar. 19, 2018
(86) PCT No.: PCT/KR2018/003141

§ 371 Date: Jun. 19, 2020

(30) Foreign Application Priority Data
Dec. 21, 2017 (KR) 10-2017-0176722

(51) Int. Cl. G06K 9/00; H04N 21/81; H04N 21/84

(52) U.S. Cl. CPC G06K 9/00724; G06K 2009/00738; H04N 21/84; H04N 21/8126

(57) ABSTRACT

The present invention relates to a sports game recording and broadcasting system which broadcasts a local amateur sports game using an ordinary camera or smartphone camera, rather than an expensive camera for sports game, for economical and stereoscopically dynamic broadcasting and game-records inputting of the local amateur sports game. Particularly, the present invention relates to a sports game recording and broadcasting system which can systematically input and manage, in an easy and convenient manner through a touch-type recording terminal, game records of local amateur sports players participating in the sports game.

### TECHNICAL FIELD

The present invention relates to a sports game recording and broadcasting system using a smart device, and more particularly, to a system for economically broadcasting a sports game of citizens by using a smartphone camera rather than an expensive camera for a sports game.

In addition, in order to stereoscopically and dynamically broadcast the sports game, the present invention may stereoscopically and dynamically broadcast the sports game of citizens from various angles by using a plurality of smartphone cameras of different models.

Further, the present invention may easily generate and store game records of players participating in the sports game.

### BACKGROUND ART

In the 21^{st} century, the field of physical culture in Korea is changing from elite physical culture to sports-for-all physical culture due to the economic development and the expansion of a five-day workweek. Compared to the elite physical culture focusing on a small number of professional sports players, the sports-for-all physical culture allows everyone in the general public to participate so as to enjoy sports for the purpose of sound leisure activities and friendship promotion without burdens.

Various types of sports in the sports-for-all physical culture such as baseball, soccer, basketball, and golf are actively played. Referring to the baseball among such sports, with the popularity of Korean professional baseball, many people are actively playing baseball as amateur baseball players, as the base of the baseball expands from watching baseball to citizen baseball in which citizens actually participate in a game.

Meanwhile, although game conditions including a baseball field are insufficient in amateur citizen baseball other than professional baseball, many teams are being organized all over the country, and many players are playing baseball, so that various attempts are being made to improve the game conditions.

In the baseball league of citizens activated by region, baseball games of citizens are being played in accordance with Korean baseball rules while keeping and managing game records, and the baseball league of citizens is systematically developing as game videos are stored and released by using an ordinary camera or a camera for a smart device. The following are related arts relevant to the above contents.

### RELATED ART DOCUMENT

1. Korean Unexamined Patent Publication No. 10-2013-0105974: Method of Providing Baseball Broadcasting Service by Using Smart Device

The invention of related art document 1 relates to a method of providing a service for broadcasting a baseball game of citizens in real time by using a smart device.

However, the invention of related art document 1 has a disadvantage in that a game video is monotonous without being stereoscopic because the game video is captured by a small number of smart device cameras.

2. Korean Unexamined Patent Publication No. 10-2015-0090984: Method and Device for Broadcasting Baseball Game of Citizens

The invention of related art document 2 enables a large number of ordinary people to watch the baseball game of citizens by recording the baseball game of citizens and broadcasting the recorded video through a store of a sponsor and the like.

However, the invention of related art document 2 has a disadvantage in that the invention is not dynamic because the invention provides a recorded broadcast, and it is difficult to be immersed in a content of the game because an advertisement content of the sponsor is input.

3. Korean Unexamined Patent Publication No. 10-2014-0127030: Integrated Baseball Record System

The invention of related art document 3 relates to an integrated baseball game record system for activating citizen baseball.

However, the invention of related art document 3 has a disadvantage in that there is no separate function for broadcasting a game, while a function of recording a baseball game of citizens is emphasized.

### DETAILED DESCRIPTION OF THE INVENTION

### Technical Problem

In order to solve the above problems, an object of the present invention is to provide a system for economically broadcasting a sports game of citizens by using a smart device camera rather than an expensive camera for a sports game.

In addition, an object of the present invention is to provide a system for stereoscopically and dynamically broadcasting the sports game of citizens from various angles by using a plurality of smart device cameras of different models in order to stereoscopically and dynamically broadcast the sports game.

Further, an object of the present invention is to easily generate and store game records of players participating in the sports game.

### Technical Solution

In order to achieve the above objects, according to the present invention, there is provided a system for broadcasting a sports game by using a smart device, the system including:

a recording terminal (100) for receiving player information for each team participating in a sports game, generating and storing player-specific game record information of a corresponding game, providing the generated player-specific game record information of the corresponding game to a record management server (300), displaying videos captured by a plurality of cameras (200), and providing video information about one of the displayed videos and the player-specific game record information to an external server (20);

the cameras (200) for capturing the video related to the sports game to provide video information about the captured video to the recording terminal (100); and the record management server (300) for receiving the player-specific game record information of the corresponding game from the recording terminal (100) to generate and store player-specific integrated game record information, and providing the generated player-specific integrated game record information to the recording terminal (100).

### Advantageous Effects of the Invention

The sports game recording and broadcasting system using the smart device according to the present invention is a system for economically broadcasting a sports game of citizens by using an inexpensive ordinary camera (e.g., a smartphone camera) rather than an expensive camera for capturing a sports game, so that the system can provide a great assistance in activating citizen baseball.

In addition, according to the present invention, the system stereoscopically and dynamically broadcasts the sports game of citizens from various angles by using a plurality of smartphone cameras of different models in order to stereoscopically and dynamically broadcast the sports game, so that a social interest in citizen baseball can be induced by sharing a broadcasted video on YouTube and the like when the broadcasting is terminated.

In addition, according to the present invention, a touch screen formed on a recording terminal can be used to rapidly and simply record citizen sports game records in real time without a separate input device, so that the present invention can be conveniently used regardless of a place.

Further, the present invention not only simply records the game, but also visually displays a game content in a graph, so that the present invention is convenient to use and can be used as a reference upon the broadcasting of the game.

Furthermore, the present invention transmits the game records to a main server immediately after the game is over to manage the citizen sports game records, so that the baseball league of citizens can be systematically activated.

### DESCRIPTION OF THE DRAWINGS

FIG. 1 is a conceptual diagram showing a sports game recording and broadcasting system using a smart device according to the present invention.

FIG. 2 is a view showing a state in which the sports game recording and broadcasting system using the smart device according to the present invention is connected to an external server.

FIG. 3 is a block diagram showing a sub-configuration of a recording terminal of the sports game recording and broadcasting system using the smart device according to the present invention.

FIG. 4 is a view showing a state of a recording screen of the sports game recording and broadcasting system using the smart device according to the present invention.

FIG. 5 is a view showing a state of screen switching performed by a display control unit of the sports game recording and broadcasting system using the smart device according to the present invention.

FIG. 6 is a view showing a camera of the sports game recording and broadcasting system using the smart device according to the present invention.

FIG. 7 is a view illustrating a playing field screen and a player icon of the sports game recording and broadcasting system using the smart device according to the present invention.

FIG. 8 is a view illustrating a game content display icon of the sports game recording and broadcasting system using the smart device according to the present invention.

FIG. 9 is a view illustrating a pitching content icon of the sports game recording and broadcasting system using the smart device according to the present invention.

FIG. 10 is a view showing a state of generating a batter record in the sports game recording and broadcasting system using the smart device according to the present invention.

FIG. 11 is a view illustrating a game record item for generating a player-specific game record in the sports game recording and broadcasting system using the smart device according to the present invention.

### DESCRIPTION OF REFERENCE NUMERALS

10: Broadcasting system
20: External server
100: Recording terminal
200: Camera
300: Record management server
400: Format integration unit
500: Recording screen

### BEST MODE

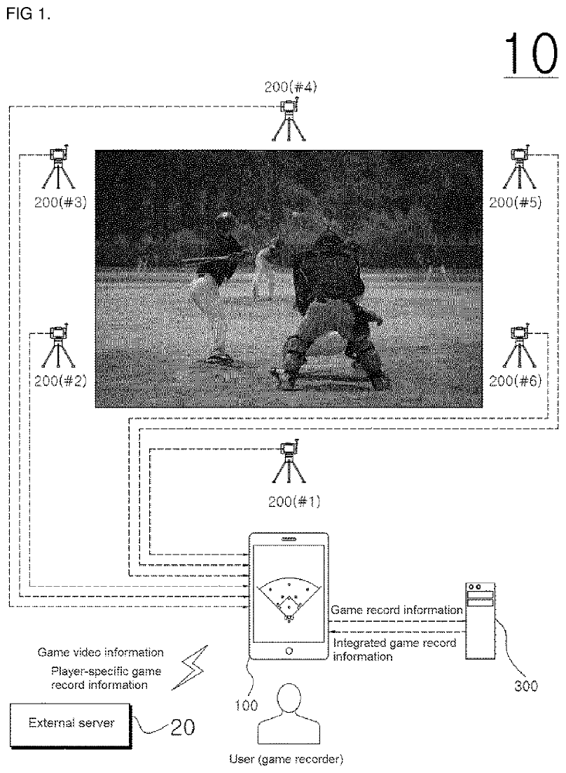

An embodiment of the present invention as described above will be described in detail with reference to FIGS. 1 to 11.

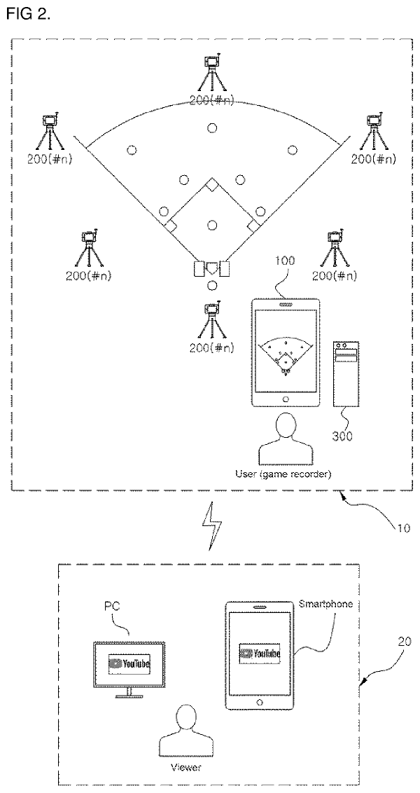

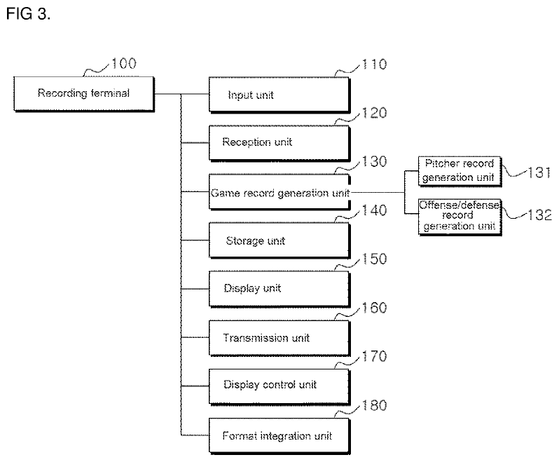

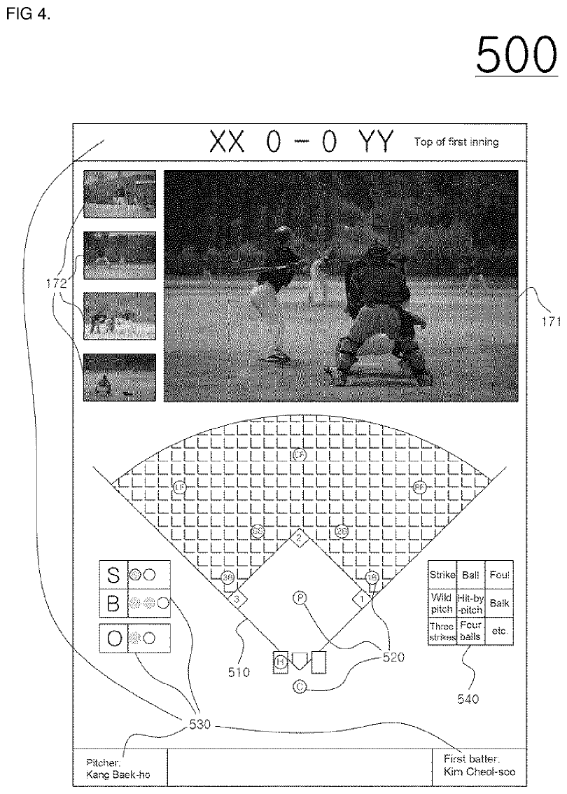

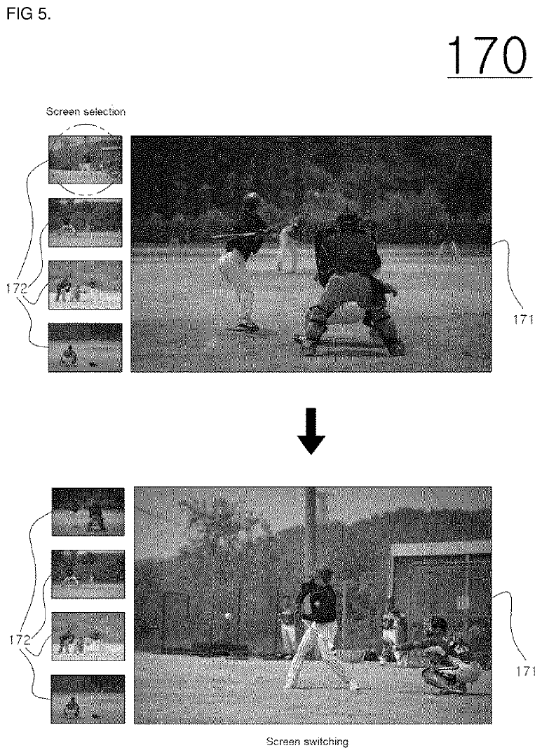

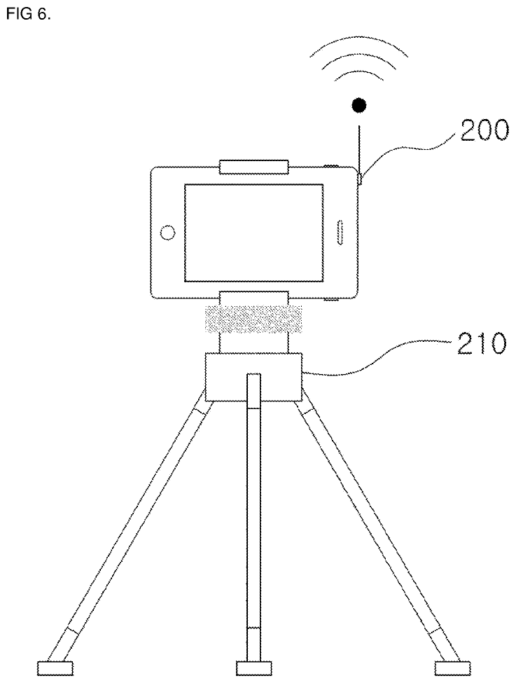

FIG. 1 is a conceptual diagram showing a sports game recording and broadcasting system using a smart device according to the present invention, FIG. 2 is a view showing a state in which the sports game recording and broadcasting system using the smart device according to the present invention is connected to an external server, FIG. 3 is a block diagram showing a sub-configuration of a recording terminal of the sports game recording and broadcasting system using the smart device according to the present invention, FIG. 4 is a view showing a state of a recording screen of the sports game recording and broadcasting system using the smart device according to the present invention, FIG. 5 is a view showing a state of screen switching performed by a display control unit of the sports game recording and broadcasting system using the smart device according to the present invention, and FIG. 6 is a view showing a camera of the sports game recording and broadcasting system using the smart device according to the present invention.

Referring to FIGS. 1 and 2, a sports game recording and broadcasting system 10 using a smart device according to the present invention may be a system for broadcasting and recording a sports game by using a recording terminal that is a smart device, and transmitting game video information and game record information to an external server 20 (e.g., an Internet broadcasting system server).

In particular, the present invention is preferably applied to a system for broadcasting a sports game of citizens in which the citizens participate in an economical way at a low cost, rather than a professional sports game broadcasted by a terrestrial broadcasting station, but the present invention does not have a limit in broadcasting the professional sports game.

According to the present invention, the sports game recording and broadcasting system 10 may include a recording terminal 100, a plurality of cameras 200, and a record management server 300.

A device having a touch screen function that enables an input by a screen touch without a separate input device and a communication function for transmitting and receiving data to and from the external server may be suitable as the recording terminal 100, and the recording terminal 100 may include a smartphone, a notebook PC (laptop PC), and a tablet PC, in which the tablet PC is preferably used as the recording terminal 100.

Referring to FIG. 3, the recording terminal 100 may provide a recording screen 500 for inputting player-specific game records of a sports game so that a user who is a game recorder may use the broadcasting system 10 according to the present invention through a graphic user interface (GUI). The recording terminal 100 may receive player information for each team participating in the sports game, generate and store player-specific game record information of a corresponding game in a touch scheme, display videos captured by the cameras 200, and provide video information about one of the displayed videos and the player-specific game record information to the external server 20. To this end, the recording terminal 100 may include an input unit 110, a reception unit 120, a game record generation unit 130, a storage unit 140, a display unit 150, a transmission unit 160, a display control unit 170, and a format integration unit 180.

The input unit 110 is an input device for receiving the player information for each team, which includes position information of players participating in a game, in which the input unit 110 may receive the player information for each team from the external server 20, or the user who is the game recorder may directly input the player information for each team.

The reception unit 120 is a reception device for receiving video information captured by the cameras 200 installed at various places in a playing field in real time, or receiving player-specific integrated game record information from the record management server 300.

The game record generation unit 130 may generate the player-specific game record information of the corresponding game by using information input in the touch scheme through the recording screen 500, and the storage unit 140 is a storage device for storing the player information for each team input through the input unit 110 and the video information received by the reception unit 120, or the player-specific integrated game record information and the player-specific game record information of the corresponding game generated by the game record generation unit 130.

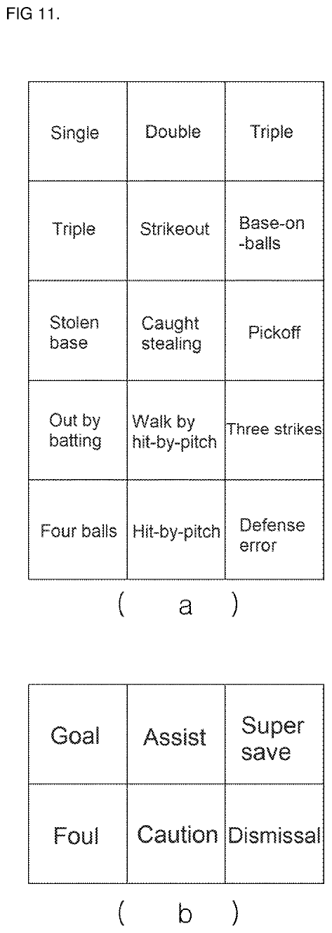

The game record generation unit 130 may display, when one of a plurality of player icons 520 arranged on the recording screen 500 is selected, game record items (see FIG. 11) for generating a player-specific game record on the recording screen 500, and may generate, when one specific item among the game record items is selected, a record corresponding to the selected specific item as a game record of a player corresponding to the selected player icon 520.

For example, in a case of a baseball game, when a pitcher icon is selected among the player icons 520, the game record items shown in FIG. 11(a) may be displayed, and a game record of three strikes may be generated as a game record of a player who is a pitcher when the three strikes, which is a specific item among the displayed game record items, is selected; when a center fielder icon is selected among the player icons 520, the game record items shown in FIG. 11(a) may also be displayed, and a game record of a defense error may be generated as a game record of a player who is a center fielder corresponding to the selected player icon 520 when the defensive error, which is a specific item among the displayed game record items, is selected; and when a batter icon is selected among the player icons 520, the game record items shown in FIG. 11(a) may also be displayed, and a game record of a double may be generated as a game record of a player who is a batter corresponding to the selected player icon 520 when the double, which is a specific item among the displayed game record items, is selected.

For example, in a case of a soccer game, when one attacker icon is selected among the player icons 520, the game record items shown in FIG. 11(b) may be displayed, and a game record of a goal may be generated as a game record of one attacker corresponding to the selected player icon 520 when the goal, which is a specific item among the displayed game record items, is selected; and when one defender icon is selected among the player icons 520, the game record items shown in FIG. 11(b) may also be displayed, and a game record of a foul may be generated as a game record of one defender corresponding to the selected player icon 520 when the foul, which is a specific item among the displayed game record items, is selected.

Although baseball and soccer have been used as examples above, it is apparent that the present invention can be applied to all types of games.

In addition, as another example of the game record generation unit 130, as shown in FIG. 3, the game record generation unit 130 may include a pitcher record generation unit 131 and an offense/defense record generation unit 132 when a type of the sports game is baseball, and as shown in FIG. 4, the recording screen 500 may include a playing field screen 510 configured in a shape of a baseball playing field corresponding to the type of the sports game, a plurality of player icons 520 arranged for each position on the playing field screen 510, a game content display icon 530 displayed on one side of the playing field screen 510 to display a game-related content, and a pitching content icon 540 for displaying a pitching content of a pitcher, such as a strike, a ball, a foul, a wild pitch, and a hit-by-pitch.

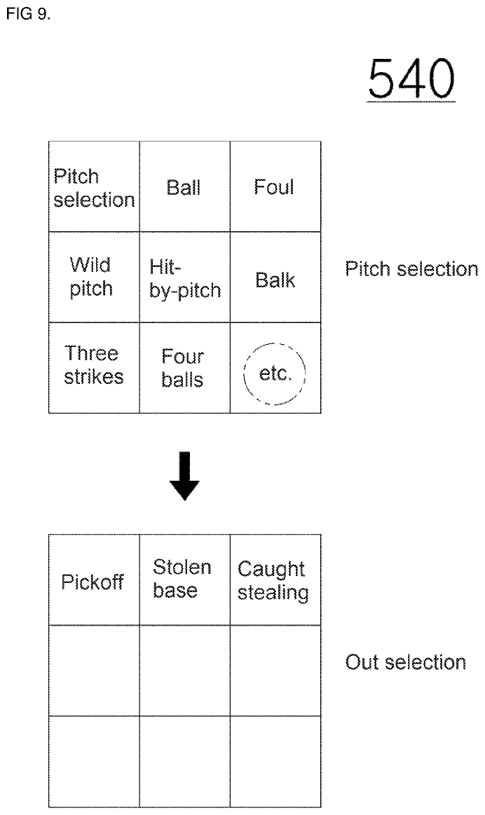

In this case, the pitcher record generation unit 131 may generate and store, when one of items in the pitching content icon 540 shown in FIG. 9 is selected according to pitching of the pitcher for one batter, a pitching content corresponding to the selected item as first information that is record information of a corresponding pitcher, may repeatedly generate the first information until the pitching for the one batter ends, may generate and store second information that is record information of the corresponding pitcher for the one batter by using the stored first information when the pitching for one batter ends, may repeatedly generate and store the first information and the second information until the game ends, and may generate and store pitcher-specific game record information of the corresponding game by using the first and second information generated and stored until the game ends.

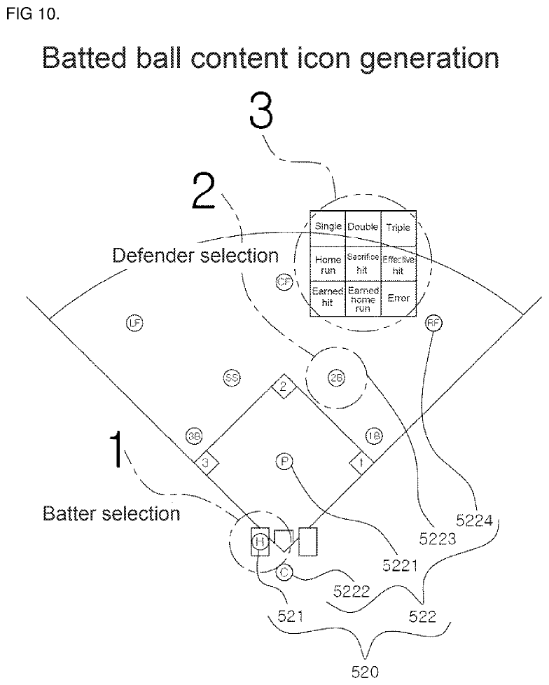

In addition, the offense/defense record generation unit 132 may generate and store, in a case where a batter hits a pitched ball, and a batter icon and a defender icon to which a batted ball is gone are selected among the player icons 520 on the recording screen 500, when batting content items (‘3’ of FIG. 10) pop up on the recording screen 500 and one of the pop-up batting content items is selected, third information that is record information about a corresponding batter and a corresponding defender according to a content of the selected item, may generate and store, in a case where the batter fails to hit the pitched ball, and only one of the items in the pitching content icon 540 on the recording screen 500 is selected, fourth information that is record information about the corresponding batter according to a selected content, may repeatedly generate and store the third information and the fourth information until the game ends, and may generate and store player-specific game record information of the corresponding game about the batting and defense by using the third and fourth information generated and stored until the game ends.

The first information may include a ball, a strike, a foul, and a hit-by-pitch, the second information may include three strikes, four balls, a single, a double, a triple, and a home run, the third information may include a single, a double, a triple, a home run, a hit by an error, a double out, a fly-out, and an error, and the fourth information may include a strikeout, four balls, and a hit-by-pitch.

The generation and storage of the player-specific game records performed by the game record generation unit 130 including the pitcher record generation unit 131 and the offense/defense record generation unit 132 will be described in detail.

The pitcher record generation unit 131 may generate and store the pitcher-specific game record information through information input by touching the pitching content icon 540 on the recording screen 500 shown in FIG. 9.

For example, when one of pitching contents is selected among pitching content icons 540 according to the pitching of the pitcher for one batter, the selected pitching content may be generated and stored as the first information that is the record information of the corresponding pitcher.

In more detail, in a case where the pitcher throws a first pitch and a corresponding pitch is judged as a ball, when the recorder touches the ball among the pitching content icons 540 of FIG. 9, the ball may be stored as a game record of the corresponding pitcher for the first pitch, and simultaneously, the ball may be displayed on an icon 531 that indicates ball counts among game content display icons 530.

Thereafter, in a case where the pitcher throws a second pitch and a corresponding pitch is judged as a strike, when the recorder touches the strike among the pitching content icons 540 of FIG. 9, one strike and one ball may be stored as game records of the corresponding pitcher for a total of two pitches, and simultaneously, one ball and one strike may be displayed on the icon 531 that indicates the ball counts among the game content display icons 530. The first information may include a ball, a strike, a foul, a hit-by-pitch, and a balk.

The pitching of the pitcher for one batter may be continuously recorded as described above, and when offense of the batter ends without the batting, game records such as three strikes, four balls, and a hit-by-pitch may be generated and stored as game records of the pitcher.

If the batter hits a pitch (e.g., a fifth pitch) of the pitcher so as to hit a single to a right fielder, when the recorder sequentially selects the batter icon and a right fielder icon among the player icons 520 on the recording screen, the batting content items indicated by ‘3’ in FIG. 10 may pop up, and the singe to the right fielder, which is an earned hit, may be stored as the game record of the corresponding pitcher when the single is selected among the items.

In this case, the singe to the right fielder may be stored as the game record of the batter, and the detailed description thereof will be given below in the description of the offense/defense record generation unit 132.

The first information may be repeatedly generated until the pitching for the one batter ends, the game record (one of three strikes, four balls, a hit-by-pitch, a single, a double, a triple, and a home run) of the pitcher for the batter may be determined according to the stored first information when the pitching for one batter ends, and the determined record may be generated and stored as the second information that is game record information of the corresponding pitcher.

The second information may include three strikes, four balls, an earned hit by a single, an earned hit by a double, an earned hit by a triple, and a home run.

The first information and the second information may be repeatedly generated and stored until the game ends, and the pitcher-specific game record information of the corresponding game may be generated and stored by using the first and second information generated and stored until the game ends.

The offense/defense record generation unit 132 may generate and store the player-specific game record information about the batting and the defense during the game except for the pitcher.

The player-specific game record information about the batting and the defense may include information such as a hit, a home run, a walk by an error, a double out, an out, three strikes, and four balls, which is the game record information about the batter, and record information including an error, which is the game record information about the defense.

In the case where the batter hits the pitched ball, and the batter icon and one defender icon to which the batted ball is gone are sequentially selected among the player icons 520 on the recording screen 500, the offense/defense record generation unit 132 may allow the batting content items (‘3’ of FIG. 10) to pop up on the recording screen 500.

For example, when a batter icon 311 of ‘1’ in FIG. 10 is touched, and a second baseman icon of ‘2’ in FIG. 10 is touched, the batting content items of ‘3’ in FIG. 10 may pop up.

The pop-up batting content items may include a single, a double, a triple, a home run, a walk by an error, a double out, fly-out, and the like, which are the game record information about the batter, and an error which is the game record information about the defender.

When one of the pop-up batting content items is selected, the offense/defense record generation unit 132 may generate and store the third information that is the record information about the corresponding batter and the corresponding defender according to the content of the selected item.

For example, when the single is selected among the batting content items, third information that is the single may be generated and stored as the game record of the corresponding batter, and third information that is an earned hit by the single to a right fielder may be generated and stored as the game record of the pitcher.

If the right fielder accidentally fails to catch the batted ball, the error may be selected among the batting content items, third information that is the error may be generated and stored as the game record of the corresponding defender, and third information that is a walk by the error may be generated and stored for the corresponding batter.

If the batter fails to hit the pitched ball, and only one of the items is selected among the pitching content icons 540 on the recording screen 500, the offense/defense record generation unit 132 may generate and store the fourth information that is the record information about the corresponding batter according to the selected content. The fourth information may include a strikeout, four balls, and a hit-by-pitch.

For example, when three strikes is selected among the pitching content icons 540, the fourth information that is a strikeout may be generated and stored as a record of the corresponding batter. Naturally, the three strikes may be generated and stored as a game record of the pitcher.

The offense/defense record generation unit 132 may repeatedly generate and store the third information and the fourth information until the game ends, and may generate and store the player-specific game record information of the corresponding game about the batting and the defense by using the third and fourth information generated and stored until the game ends.

The display unit 150 is a kind of a touch screen for displaying the video information received by the reception unit 120, and displaying a touch-type recording screen 500 for inputting the player-specific game record information of the corresponding game.

Referring to FIG. 4, the recording screen 500 may be implemented on the display unit 150 through the GUI, and the description of the recording screen 500 will be described below.

The transmission unit 160 may transmit the video information about one of the videos displayed on the recording screen 500 and the player-specific game record information to the external server 20, or may transmit the player-specific game record information of the corresponding game generated by the game record generation unit 130 to the record management server 300.

In particular, the player-specific game record information provided to the external server 20 through the transmission unit 160 may include at least one of the player-specific game record information of the corresponding game generated by the game record generation unit 130 or the player-specific integrated game record information provided by the record management server 300.

The player-specific game record information of the corresponding game is player-specific game record information about a game that is currently being broadcasted, and the player-specific integrated game record information is player-specific game record information about all games accumulated until a present time.

The display control unit 170 is configured to display the videos captured by the cameras 200 on the recording screen 500. The display control unit 170 may display one of the videos captured by the cameras 200 on a main screen portion 171 while displaying the remaining videos on a thumbnail screen portion 172, and when one of the videos displayed on the thumbnail screen portion is touched, the display control unit 170 may display the touched video on the main screen portion.

In this case, the recording screen 500 may include the main screen portion 171 and the thumbnail screen portion 172.

The main screen portion 171 is a portion displayed on the recording screen 500 of the display unit 150 with a size of a main screen, and the thumbnail screen portion 172 is a portion in which a plurality of small screens in the form of thumbnails are displayed on the recording screen 500 of the display unit 150.

In other words, the display control unit 170 may display the video information captured by the cameras 200 separately in the main screen portion 171 and the thumbnail screen portion 172 as shown in FIG. 5 according to a game situation.

In this case, when one of the videos displayed on the thumbnail screen portion is touched, the display control unit 170 may perform a video switching process so that the touched image may be displayed on the main screen portion. FIG. 5 shows a state in which selected one video on the thumbnail screen portion 172 is being switched to be displayed on the main screen portion 171.

In this case, the transmission unit 160 may transmit the video information of the video displayed on the main screen portion 171 to the external server 20 under the control of the display control unit 170.

The external server 20 refers to a video sharing channel such as a citizen game league website or YouTube.

Referring to FIG. 6, the cameras 200 are ordinary video capturing devices such as smartphone cameras or ordinary cameras rather than expensive cameras for a sports game, and the cameras 200 may capture a video for each player participating in the sports game and the video related to the game to provide the video information about the captured videos to the recording terminal 100.

Meanwhile, since all the cameras 200 are not products of the same model, video data of the videos captured by the cameras 200 may have different formats. If the video data having different formats is directly transmitted to the external server 20, a problem may occur when broadcasting the videos of the external server 20.

In the present invention, in order to solve the above problem, the recording terminal 100 further includes the format integration unit 180.

In other words, according to the present invention, the format integration unit 180 converts the video data of the video captured by the cameras 200 such that the video data has a preset format to provide the converted video data to the external server 20, so that a video broadcasting problem due to a difference in video formats can be solved when broadcasting the videos of the external server 20.

Referring to FIGS. 1 and 2, the record management server 300 is a component for receiving the player-specific game record information of the corresponding game from the recording terminal 100 to generate and store the player-specific integrated game record information, and providing the generated player-specific integrated game record information to the recording terminal 100. When the recording terminal 100 generates and provides the player-specific game record information for each game, the record management server 300 may generate and store the player-specific integrated game record information about all games accumulated until the present time, so that the player-specific game records can be systematically managed, and the player-specific integrated game record information can be provided to the recording terminal 100 when necessary.

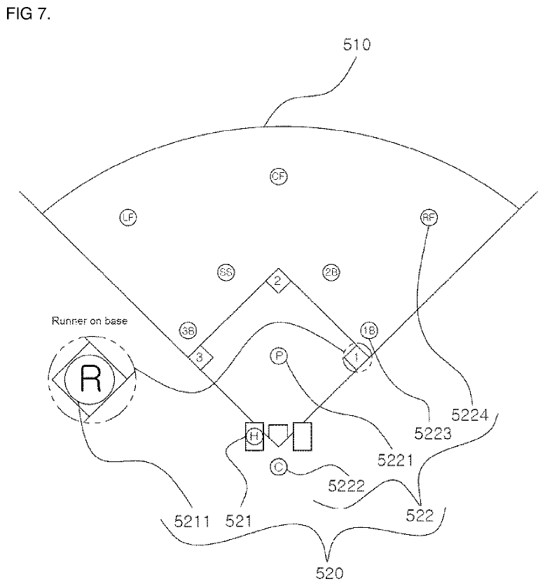

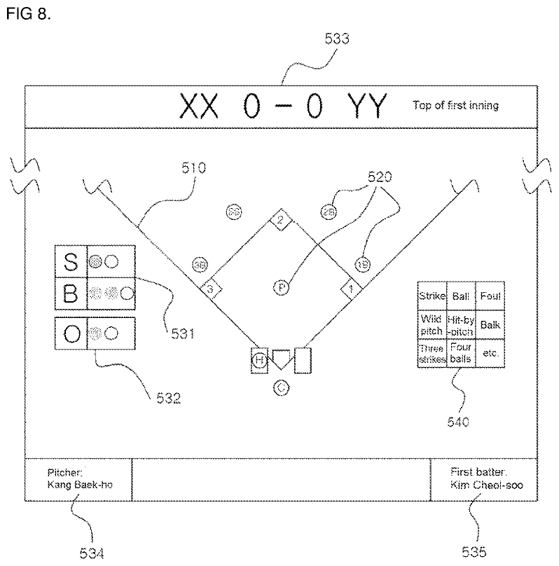

FIG. 7 is a view for describing a playing field screen 510 and a plurality of player icons 520 of the sports game recording and broadcasting system using the smart device according to the present invention, and FIG. 8 is a view for describing a game content display icon 530 of the sports game recording and broadcasting system using the smart device according to the present invention.

As shown in FIG. 4, the present invention inputs the game record through the recording screen 500 to which the GUI and the touch scheme are applied and visually displays the game-related video, so that the recorder who is the user can conveniently input the game record while watching the related video or transmit the game-related video to an outside.

Hereinafter, the recording screen 500 will be described in detail.

Referring to FIGS. 7 and 8, the recording screen 500 is a touch-type input screen for recording a game implemented on the display unit 150 of the recording terminal 100, and may include a playing field screen 510, a plurality of player icons 520, and a game content display icon 530.

The playing field screen 510 is configured as a screen having a shape of a playing field corresponding to a type of a corresponding sports game. FIGS. 7 and 8 illustrate a playing field screen 510 configured in the shape of the baseball playing field when the type of the sports game is baseball, and it is apparent that the playing field screen 510 may be configured as a screen having a shape of a corresponding playing field when the type of the corresponding sports game is soccer, basketball, volleyball, or the like.

The player icons 520 are kinds of player identification icons arranged for each player position on the playing field screen 510, and may represent positions for each player.

FIGS. 7 and 8 illustrate a state in which icons 520 of players participating in a baseball game are arranged on the playing field screen 510 configured in the shape of the baseball playing field when the type of the sports game is baseball, and it is apparent that icons of players participating in a corresponding game may be arranged on the playing field screen 510 configured in a shape of a playing field of soccer, basketball, volleyball, or the like according to positions of the corresponding game when the type of the corresponding sports game is soccer, basketball, volleyball, or the like.

For example, when the baseball game shown in FIG. 7 is described with respect to the player icons 520, player icons indicated by a reference numeral ‘520’ in FIG. 7 may be broadly divided into a batter icon 521 and a defender icon 522, and the defender icon 522 may include a pitcher icon 5221, a catcher icon 5222, a second baseman icon 5223, a right fielder icon 5224, and the like.

The game content display icon 530 is an icon displayed on one side of the playing field screen 510 to display a game-related content, and may include a plurality of icons for checking a game score, a game progress, and player information.

FIG. 8 illustrates the game content display icon 530 applied to the baseball game, and the game content display icon 530 will be described with reference to FIG. 8.

The icon 531, which is one of the game content display icons 530, is an icon representing strike and ball counts, an icon 532, which is one of the game content display icons 530, is an icon representing an out count, an icon 533, which is one of the game content display icons 530, is an icon representing a game score, and icons 534 and 535, each of which is one of the game content display icons 530, are icons for checking player information.

In particular, when the icons 534 and 535, each of which is one of the game content display icons 530, are selected, game record information of a corresponding player (a pitcher or a batter in a case of FIG. 8) may be checked.

In addition, when the type of the game is baseball, the recording screen 500 may further include a pitching content icon 540 for displaying a pitching content of a pitcher, such as a strike, a ball, a foul, a wild pitch, and a hit-by-pitch. FIG. 8 shows an example of the pitching content icon 540.

According to the present invention as described above, a sports game of citizens can be broadcasted by using an ordinary camera or a smartphone camera rather than an expensive camera for a sports game through a video sharing channel such as a citizen game league website or YouTube in order to economically, stereoscopically, and dynamically broadcast the sports game of the citizens and input game records of the sports game. In particular, the game records of citizen sports players participating in the corresponding sports game can be conveniently and systematically input and managed through a touch-type recording terminal, so that a social interest in the sports game of the citizens can be induced, and valuable game records can be provided to the citizen players participating in the game.

### INDUSTRIAL APPLICABILITY

The sports game recording and broadcasting system using the smart device according to the present invention is a system for economically broadcasting a sports game of citizens by using an inexpensive ordinary camera (e.g., a smartphone camera) rather than an expensive camera for capturing a sports game, so that the system can provide a great assistance in activating citizen baseball so as to have high industrial applicability.

1. A sports game recording and broadcasting system using a smart device, the sports game recording and broadcasting system comprising:
a recording terminal for receiving player information for each team participating in a sports game, generating and storing player-specific game record information of a corresponding game in a touch scheme, providing the generated player-specific game record information of the corresponding game to a record management server, displaying videos captured by a plurality of cameras, and providing video information about one of the displayed videos and the player-specific game record information to an external server;
the cameras for capturing a video related to the sports game to provide video information about a captured video to the recording terminal; and
the record management server for receiving the player-specific game record information of the corresponding game from the recording terminal to generate and store player-specific integrated game record information, and providing the generated player-specific integrated game record information to the recording terminal.

2. The sports game recording and broadcasting system of claim 1, wherein the recording terminal includes:
an input unit for receiving the player information for each team, which includes position information of players participating in the game;
a reception unit for receiving the video information about the video captured by the cameras in real time, and receiving the player-specific integrated game record information from the record management server;
a game record generation unit for generating the player-specific game record information of the corresponding game;
a storage unit for storing the player information for each team input through the input unit, the video information received by the reception unit, and the player-specific game record information of the corresponding game generated by the game record generation unit;
a display unit for displaying the video information received by the reception unit, and displaying a touch-type recording screen for inputting the player-specific game record information of the corresponding game; and
a transmission unit for transmitting the video information about one of the videos displayed on the recording screen and the player-specific game record information to the external server, and transmitting the player-specific game record information of the corresponding game generated by the game record generation unit to the record management server, and wherein the player-specific game record information transmitted to the external server by the transmission unit includes at least one of the player-specific game record information of the corresponding game generated by the game record generation unit or the player-specific integrated game record information provided by the record management server.

3. The sports game recording and broadcasting system of claim 2, wherein the recording terminal further includes a format integration unit, and the format integration unit converts video data of the video captured by the cameras such that the video data has a preset format.

4. The sports game recording and broadcasting system of claim 2, wherein the recording screen displayed on the display unit includes at least:
a playing field screen configured in a shape of a playing field corresponding to a type of the sports game,
a plurality of player icons arranged for each position on the playing field screen, and
a game content display icon displayed on one side of the playing field screen to display a game-related content.

5. The sports game recording and broadcasting system of claim 4, wherein the game record generation unit displays, when one of the player icons arranged on the recording screen is selected, game record items for generating a player-specific game record on the recording screen, and generates, when one specific item among the game record items is selected, a record corresponding to the selected specific item as a game record of a player corresponding to the selected player icon.

6. The sports game recording and broadcasting system of claim 2, wherein:
the recording terminal further includes a display control unit,
the recording screen includes a main screen portion and a thumbnail screen portion, and
the display control unit displays one of the videos captured by the cameras on the main screen portion while displaying remaining videos on the thumbnail screen portion, and displays, when one of the videos displayed on the thumbnail screen portion is touched, the touched video on the main screen portion.

7. The sports game recording and broadcasting system of claim 6, wherein the video information transmitted to the external server by the transmission unit includes video information about the video displayed on the main screen portion of the recording screen.

8. The sports game recording and broadcasting system of claim 2, wherein:
the game record generation unit includes a pitcher record generation unit and an offense/defense record generation unit when a type of the sports game is baseball,
the recording screen includes a playing field screen configured in a shape of a playing field corresponding to the type of the sports game, a plurality of player icons arranged for each position on the playing field screen, a game content display icon displayed on one side of the playing field screen to display a game-related content, and a pitching content icon for displaying a pitching content of a pitcher, such as a strike, a ball, a foul, a wild pitch, and a hit-by-pitch,
the pitcher record generation unit:
generates and stores, when one of items in the pitching content icon is selected according to pitching of the pitcher for one batter, a pitching content corresponding to the selected item as first information that is record information of a corresponding pitcher,
repeatedly generates the first information until the pitching for the one batter ends, generates and stores second information that is record information of the corresponding pitcher for the one batter by using the stored first information when the pitching for one batter ends,
repeatedly generates and stores the first information and the second information until the game ends, and
generates and stores pitcher-specific game record information of the corresponding game by using the first and second information generated and stored until the game ends,
the offense/defense record generation unit:
generates and stores, in a case where a batter hits a pitched ball, and a batter icon and a defender icon to which a batted ball is gone are selected among the player icons on the recording screen, when batting content items pop up on the recording screen and one of the pop-up batting content items is selected, third information that is record information about a corresponding batter and a corresponding defender according to a content of the selected item,
generates and stores, in a case where the batter fails to hit the pitched ball, and only one of the items in the pitching content icon on the recording screen is selected, fourth information that is record information about the corresponding batter according to a selected content, repeatedly generates and stores the third information and the fourth information until the game ends, and
generates and stores player-specific game record information of the corresponding game about the batting and defense by using the third and fourth information generated and stored until the game ends, and
the first information includes a ball, a strike, a foul, and a hit-by-pitch, the second information includes three strikes, four balls, a single, a double, a triple, and a home run, the third information includes a single, a double, a triple, a home run, a hit by an error, a double out, a fly-out, and an error, and the fourth information includes a strikeout, four balls, and a hit-by-pitch.
